(19) United States
(12) Patent Application Publication
(10) Pub. No.: US 2005/0127559 A1
(43) Pub. Date: Jun. 16, 2005

(54) Homogenizing multimodal polymer

(76) Inventors: Svein Staal Eggen, Langangen (NO); Arne Syre, Stathelle (NO)

Correspondence Address: NIXON & VANDERHYE, PC, 1100 N GLEBE ROAD, 8TH FLOOR, ARLINGTON, VA, 22201-4714, US

(21) Appl. No.: 10/507,494

(22) PCT Filed: Mar. 13, 2003
(86) PCT No.: PCT/EP03/02650

(30) Foreign Application Priority Data
Mar. 13, 2002 (GB) 0205932.7

(51) Int. Cl. B29C 47/38; B29C 47/60

(52) U.S. Cl. 264/211.21; 264/211.23; 425/204

(57) ABSTRACT

A method of homogenizing polypropylene using twin counter-rotating screws with a melting stage and a separate downstream mixing phase. The polypropylene is melted to at least 5° C. above its melting point in the melting stage and passed through a gate valve into the mixing section. The elongational stress applied to the polymer in the mixing section is at least 20% greater than that of conventional counter-rotating extruders and causes a Henchy strain of between 1.5 and 2.5 in the polymer. This causes significant strain hardening within the polymer sufficient to break up gels within the polypropylene, thereby producing a polymer with no visible white spots.

The present invention relates to the manufacture of multimodal polymers. More particularly, it relates to the homogenization of multimodal polypropylene.

In a conventional polymer there is a distribution of molecular weights termed the molecular weight distribution (MWD) centred about a single point corresponding to the average length of polymer chain. This distribution is a significant determinant of the characteristics of the polymer. It can be varied by changing the reactor conditions, catalysts used etc. It will be appreciated that both the average molecular weight and the width of the distribution can be varied. A polymer having such a distribution with a single peak is said to have a single “mode”.

It is sometimes desired to combine the properties of high molecular weight and low molecular weight polymers. To achieve this result it is possible to make so-called multimodal polymers that have distribution curves with a plurality of peaks. Thus, a bimodal polymer is one having two such peaks.

In a true bimodal polymer these peaks correspond to different chain lengths of the same polymer that are typically produced by passing the reactants through two reactors in series, one of which forms polymer having a high molecular weight and the other polymer having a lower molecular weight. This is to be distinguished from polymers having essentially a single mode to which different materials (which may well have different molecular weights) are subsequently added by blending or mixing in order to achieve desired properties.

It is, for example, known to make bimodal polyethylene using a process in which two reactors in series form polyethylene having two molecular weight peaks. As in conventional polyethylene manufacture, this results in a polymer powder that is then formed into pellets for distribution. This is achieved in a pelletiser that melts and mixes the powder before it is extruded through a die and sliced into pellets.

The conventional pelletiser for commercial scale plants usually has twin screws arranged parallel to each other within an elongate housing. The screws may be set to rotate the same way (co-rotating) or the opposite way (counter-rotating) to each other. The polymer powder is fed into one end of the apparatus and transported along it to the other by means of the screws. As it travels it is melted and then thoroughly mixed and homogenised ready for being formed into pellets.

As a general rule, machines having counter-rotating screws are advantageous because they can be made shorter than co-rotating machines. As well as saving materials and space, this also simplifies design because it is difficult to prevent long screws from flexing under load.

Several companies, including Japan Steel Works, Kobe Steel and Farrel, manufacture large counter-rotating extruders that are capable of producing up to 40 tonnes/hour of pelletized polyethylene.

These machines typically have a number of sections along the length of the screws. First there is a feeding section that receives the polymer powder and melts it. This leads in turn to a mixing section. A gate valve controls the flow of polymer between the mixing section and a further feeding (transporting) section that leads either directly, or via a second mixer, to a gear pump. The gear pump is used to feed the molten polymer to the pelletiser where it is forced through a die having a large number of small diameter holes. As the polymer passes through these holes it is chopped into pellets by a rotary knife.

No external heating is required. Instead, the powder is worked between the counter-rotating screws and against the walls of the chamber. This working results in frictional heating of the powder that causes it to melt and be thoroughly mixed together. The degree of mixing and melting can be controlled by varying the pitch of the screws along their length. Consequently, different pitches are used in the different sections.

The gate valve controls the flow of the melted polymer from the mixing section. By partially closing the gate valve the flow can be restricted, thereby causing back-flow within the previous section and increasing the residence time of the polymer therein.

The gear pump is designed to deliver the mixed polymer to the pelletiser without significant further mixing.

The mixer stage is crucial to the operation of the device. Here the screws are designed such that the molten polymer undergoes strong shear and elongational deformation to reduce the amount of large molecular weight domains (hereinafter referred to as “gels”) in the polymer. The higher molecular weight polymer may thereby be thoroughly mixed with the lower molecular weight polymer. The action of the screws is well known. See for example Utracki and Luciani, Applied Rheology, January 2000.

If the polymer is not properly homogenised, the gels appear as so-called white spots in the finished product. In the past, where this problem occurred, the response was to apply larger amounts of deformation energy to the polymer composition. However, as discussed in the applicant's earlier patent application WO 00/01473, this results in degradation of the polymer and requires excessive energy input. The document further teaches that mixing polymers by causing elongational deformation is more effective and favourable than mixing by pure shear deformation. It discloses an improved apparatus for homogenizing in particular multimodal polyethylene by elongational deformation.

This mixing by elongational deformation is termed dispersive mixing and the result is an extremely thorough mixing whereby in the finished product individual domains of different modes of polymer cannot be identified even on a microscopic basis. This is in contrast with “distributive mixing” where the domains are merely spread more evenly throughout the polymer. When a multimodal polymer has undergone dispersive mixing the domains are comparable in size to the crystals of polymer and are therefore generally less than 10 μm in diameter.

However, although the prior art apparatus has been used to produce high quality bimodal polyethylene, the inventors have found that serious problems arise if it is employed in the manufacture of bimodal polypropylene. In particular, it has been found that the result is a highly inhomogeneous material containing gels of high molecular weight polypropylene.

In view of the success of the devices discussed above in a homogenizing multimodal polyethylene, it would be expected that the problems encountered when they are used to homogenise multimodal polypropylene would be overcome by increasing the residence time of the polymer in the device in order to increase the degree of mixing. However, surprisingly, it has been found that this is not effective. Indeed, it has been found that even very long residence times do not provide a significant improvement.

According to the present invention there is provided a method of homogenizing polypropylene comprising melting the polypropylene and subjecting it to sufficient elongation stress to cause a significant elongational strain sufficient to break up gels within the polypropylene.

The invention is based upon a realisation by the inventors that a crucial factor in homogenizing a polymer is the behaviour of the polymer under strong elongational deformation. Whereas polymers experience shear thinning, that is they become increasingly less viscose in response to increased shear stress, some polymers experience strain hardening during intense elongational deformation. Thus, when a sufficiently great elongational stress is applied to a molten polymer, it becomes more resistant to extension and consequently more “brittle”. The inventors have recognized that such strain-hardened polymer may therefore be more readily broken up. It follows that it is not the total amount of energy applied to the polymer that is critical to achieving mixing, but rather the magnitude of the elongational stress acting on the gels. Thus, by working the polypropylene such that it undergoes strain hardening, as provided by the invention, the material can be more effectively homogenised.

This phenomenon is thought to explain why the prior art apparatus that is suitable for homogenizing polyethylene is unsuitable and ineffective with polypropylene, even if a large amount of energy is applied. Investigations of elongational behaviour of some bimodal polypropylene materials show that these materials behave very differently from bimodal polyethylene. Indeed, preliminary investigations based on inlet pressure drop data in a capillary rheometer (according to methodology given by Cogswell, 1972 Trans. Soc. Rheol. 12 64-73) indicate that strain hardening for polypropylene is reached at a rate of deformation some ten times higher than for polyethylene. Thus, whilst the prior art apparatus is applying sufficient elongational stress to break up gels of polyethylene, that stress is far too small to eliminate gels in polypropylene. Thus, preferably the apparatus of the invention is arranged to apply elongational stress of at least ten times greater magnitude than the previously described devices.

It is believed that the principle of the present invention is applicable to other polymers and therefore viewed from a further aspect the invention provides a method of homogenizing a polymer comprising the steps of determining the strain hardening region of the polymer, melting and mixing the polymer, wherein the polymer is subjected to sufficient elongational stress during mixing to cause a significant strain hardening whereby to break up gels within the polymer.

Thus, by determining the strain-hardening region, the appropriate degree of applied elongational stress can be determined for any given polymer. In this way, it can be ensured that sufficient stress is applied to avoid production of polymer containing gels, whilst at the same time avoiding applying too much stress as this would result in wasted energy and possibly deterioration of the polymer.

Where the material contains a number of different polymers, or a number of modes of the same polymer, normally the strain hardening region of all polymers is determined so that all polymers (or modes) may be worked in their strain-hardening region. However, in some applications, e.g. where less thorough mixing is required, it may be appropriate to work only some of the polymers or modes in that region.

As discussed above, compared to an apparatus designed for homogenizing multimodal polyethylene, an apparatus according to the invention for homogenizing multimodal polypropylene must apply a much greater elongational stress to the molten polymer.

This may be achieved in a number of ways. The main mixing mechanism employed within counter-rotating mixers is the squeezing or calendaring of material being forced to flow between the screw shafts and/or between the flights of the screws and the barrel wall. Thus, by modifying the gaps, speeds, temperature, balance between forward/backward flow along the screw, etc., the magnitude and rate of deformation can be varied.

Of these parameters, the gaps are the most significant. Their effect is illustrated in FIG. 6 where a schematic cross section of a counter-rotating three-lobe mixer is shown. During the rotation of the screws, the material in volume A will be forced to flow between the gaps a and b as long as the volume is “closed”. The deformation on the polymer flowing through these gaps can be calculated in terms of Hencky strain (e) by the expression:—
e=ln(L/L₀)

where L₀ and L are respectively the length of a volume element before after the deformation. Thus, by modifying the free volume between the screw and the barrel walls (volume A), the gaps between screws and between screw flights and wall, and the balance between forward and backward flow along the screw, the magnitude of deformation can be changed in such a manner to obtain elongational deformation of the right strain.

The elongational stress and the rate of deformation will be affected by the changes above but can in addition be altered by varying melt temperature and speed of rotation. It is also possible to modify the geometry of the rotors to change the stresses generated.

In order to obtain acceptable results for multimodal polypropylene, the average effective elongational deformation (Hencky strain) and elongational stress applied to the polymer should preferably be increased by at least 20% and preferably by 50% compared with the conventional counter-rotating extruders commonly used for high density polyethylene.

In table 1 is shown modifications to the mixing sections of the described prior art (polyethylene mixing) devices in order to obtain the preferred 20-50% increase in Hencky strain. These figures assume three starting values for the free volume A and a gap of 1.

TABLE 1
Hencky strain for different combinations of free volume and gaps

| volume A | L0 | gap | L | Hencky strain | % change in strain |
|---|---|---|---|---|---|
| 10.0 | 3.2 | 1.0 | 10.0 | 1.2 | |
| 20.0 | 4.5 | 1.0 | 20.0 | 1.5 | |
| 30.0 | 5.5 | 1.0 | 30.0 | 1.7 | |

Modified gaps

| | | | | | |
|---|---|---|---|---|---|
| 10.0 | 3.2 | 0.7 | 14.3 | 1.5 | 31.0 |
| 20.0 | 4.5 | 0.7 | 28.6 | 1.9 | 23.8 |
| 30.0 | 5.5 | 0.7 | 42.9 | 2.1 | 21.0 |

Modified free volume

| | | | | | |
|---|---|---|---|---|---|
| 20.0 | 4.5 | 1.0 | 20.0 | 1.5 | 30.1 |
| 40.0 | 6.3 | 1.0 | 40.0 | 1.8 | 23.1 |
| 60.0 | 7.7 | 1.0 | 60.0 | 2.0 | 20.4 |

It may be seen that changing the gap affects the strain more effectively than changing the free volume and that a 30-40% reduction in gaps will give a 20% increase in strain.

At least in the case of polypropylene, it is preferred that the gaps and free volumes are arranged to produce a Henky strain of between 1.5 and 2.5 and most preferably between 1.8 and 2.2.

Preferably the design of a homogeniser according to the invention is additionally made on the basis of Theological measurements, particularly of uniaxial elongational viscosity, of appropriate materials in order to define the necessary strain and strain rate to break up the material. It will be appreciated that the ideal sizes of gap and other parameters will vary between implementations of the invention and will also vary depending on the specific material being processed.

It is nevertheless comparatively straightforward to determine when suitable values have been implemented by testing the processed polymer for gels which will be visible as white spots. One technique is to blow a film of the polymer on a laboratory-sized film blower and to count the number of visible gels per square metre. This may be done using a conventional image analysis system. Of course, ideally there should be no visible gels, but fewer than 5/m² or 10/m² is acceptable for many applications and up to 20/m² for a lower grade product which still represents an improvement over the prior art.

It will be appreciated that higher molecular weight polymers are comparatively difficult to homogenise. Prior art homogenisers generally produce poor results when the polymer contains a high molecular weight fraction having a molecular weight greater than 350,000. By means of the invention it is possible to homogenise such polymers without significant gels being visible in the finished product. Preferred forms of the invention are capable of homogenizing polymers having a molecular weight of over 500,000 and up to 1,000,000 or 1,500,000.

Indeed, this is another aspect of the invention whereby there is provided an apparatus for homogenizing multimodal polypropylene, wherein the apparatus is capable of creating sufficient elongational strain within the polypropylene that polypropylene containing a high molecular weight fraction having a weight average molecular weight of over 500,000 may be homogenized to produce a product with no visible gels, or at least gel numbers in the ranges mentioned above.

As discussed above, in order to achieve the same mixing capability, co-rotating extruders are generally much larger than counter-rotating extruders. Therefore, it is preferred that the invention be carried out using a counter-rotating device.

Provided that a sufficient elongation stress is caused to act upon the polymer, the degree of mixing achieved then depends upon ensuring that every part of the polymer is so worked. For a given design of homogeniser, the degree of mixing may therefore be increased by increasing the residence time of the polymer within the apparatus. Thus, depending on the permissible amount of gels in the material being produced, the residence time may be chosen accordingly. Thus, for a comparatively low-grade product it may be acceptable to select a residence time which ensures that there are fewer than 20 gels/m² higher rate product will require a significantly longer residence time. As discussed above, the mixer is capable of eliminating visible gels.

A further factor that must be considered when processing polypropylene is that polypropylene has a higher melting point and a lower thermal conductivity than polyethylene. Prior art devices designed for polyethylene will therefore not sufficiently melt polypropylene. It is therefore preferred also to provide enhanced or additional stages in which the polymer is melted. These should preferably be arranged such that the polymer reaches a temperature of at least 5° C. above the melting point of the polymer before reaching the mixing stage. In order to avoid energy wastage, it is further preferred that the temperature of the polymer at this stage be no more than 10° C. above its melting point.

The provision of a section that ensures that polypropylene is fully melted before reaching the mixing stage is believed to be inventive in its own right and so viewed from another aspect, there is provided an apparatus for homogenizing multimodal polypropylene comprising twin counter-rotating screws located within a housing which serve to melt and mix polymer and feed it to a downstream forming device, the apparatus comprising a melting stage and a separate downstream mixing stage, wherein the melting stages raises the temperature of the polypropylene to a temperature above its melting point before it reaches the mixing stage.

It is preferred that this aspect of the invention is provided in combination with the mixing section previously described and so, according to a still further aspect of the present invention, there is provided an apparatus for homogenizing multimodal polypropylene comprising twin counter-rotating screws located within a housing which serve to melt and mix polymer and feed it to a downstream forming device, wherein the apparatus comprises a melting stage which raises the temperature of the polypropylene to a temperature above its melting point, a mixing stage in which sufficient elongational stress is applied to cause significant strain hardening in the polypropylene and a forming stage, the stages being separated from each other along the length of the screws.

It is possible that there can be a gradual transition between the stages such that they are not clearly defined as separate stages with clear boundaries. However, more typically the sections will have screw flights having significantly different pitches with an abrupt change between the two. For example, the melting section may have a much finer pitch than the mixing stage. The transition between the two stages may therefore be defined by a significant decrease in pitch. Furthermore, a gate valve may be provided at or near the transition to enable residence time within the melting section to be controlled.

In addition to the melting and mixing stages, there may additionally be provided a feeding stage to transport the raw material to the melting stage. Thus, the polymer is first introduced into the feeding section which transports it to the melting section and then to the mixing section. Likewise, a transport section may be provided to feed the mixed polymer to the forming stage such as a pelletizer.

The melting stage is preferably designed not to perform dispersive mixing of the polymer and so it preferably does not subject it to the extreme elongational forces that are necessary to achieve this. Consequently, the provision an enlarged, enhanced or additional mixing stage compared to the prior art devices does not result in the polymer being excessively worked and its properties being degraded as previously discussed. There may be a degree of mixing, but preferably the melting stage should provide at most some distributive mixing, i.e. it distributes matrices of higher molecular weight polymer within the lower molecular weight polymer but does not break them up to any significant degree. For this reason the screw element selected for the melting stage should preferably one of the “transport” type, i.e. a screw designed primarily to move powder or polymer melt and which imparts heating energy primarily by means of friction along the wall of the housing.

As indicated above, the melting section imparts significantly more energy into the polymer than prior art devices in order to melt polypropylene effectively. There are a number of ways in which this can be achieved. As a point of comparison, a typical polyethylene mixer comprises a feeding and melting section having a length-to-diameter ratio (l/d) of about 4. This is followed by a mixing section with 2<l/d<4 which is connected via a gate valve to a transport section with l/d=4. This leads to the pelletizer.

One preferred approach is to increase the length of the feeding and melting section by adding an additional portion having l/d between 2 and 4. This is most preferably provided in the form of a first additional feeding/melting section that may be formed of conventional feeding elements or ones having lower pitch (thereby reducing the feeding capacity of the screw). This additional section has l/d between 2 and 3. It is followed by a gate valve leading to a second additional feeding section having l/d between 1 and 2. The first additional feeding/melting section enables more work to be done one the polymer to ensure that it is properly melted and the provision of a gate valve enables the residence time in the melting section to be increased without increasing further the length of the section. The second additional feeding section may also assist the melting process, but primarily serves to transport the melted polymer to the mixing section.

A refinement on the approach described above is to modify the first feeding/melting section to provide distinct feeding and melting parts. Thus, the feeding part may have l/d between 1 and 1.5 followed by a melting part with l/d in the same range. The melting part may be provided with at least a portion having a significantly more course pitch than the feeding part that will increase the rate of melting compared with a standard feeding screw. It may optionally also be designed to impart high elongational stress so that some mixing also takes place.

An alternative approach is to add a separate single or twin-screw extruder as a pre-melting stage into which the polymer is fed. Melted or part melted polymer is then transported to a mixing apparatus having a feeding/melting section that may be of essentially conventional design. The use of a separate pre-melting extruder avoids lengthening the screws of the main extruder.

The mixing section preferably comprises a mixing rotor arranged to produce forward and backward flow such that the polymer flows between the screws. The pitch of the screws, and/or the gaps between the screws and between the walls and the screws is adjusted, and/or the rotation speed is adjusted to result in flow ratio causing elongational stress in the polymer sufficient to strain harden the material. As previously noted, for polypropylene, the rate of elongational deformation required to achieve strain hardening is at least a factor of ten higher than those used for bimodal high-density polyethylene.

The preferred forms of the invention discussed above are appropriate for the construction of a production scale mixer, i.e. one having an output of at least one tonne per hour and more typically in excess of ten tonnes per hour. However, it is also useful to homogenise polymer on a laboratory scale, e.g. for purposes of quality control, experiment or analysis. An apparatus according to the invention may therefore also be produced on such a scale, for example based on Clextral 25 mm twin intermeshing screw counter-rotating components. Such an apparatus is suitable for a feeding rate of 30-70 g/minute. The screws should preferably be rotated at 90-110 (e.g. 100) RPM.

The preferred length-to-diameter ratios (l/d) are somewhat different in such a smaller scale apparatus. It has been found that a comparatively long melting section, having say l/d between 8 and 15, for example about 12 is effective. In such an apparatus a mixing section having l/d between 4 and 8, e.g. around 6 is preferred.

In one such laboratory scale embodiment there is provided a feeding section having a standard or reduced pitch that is separated from the mixing section by a gate valve. The valve is used to control the residence time in the mixing section by causing a degree of back-flow. A similar effect could however be provided by lengthening the section by 1.2 to 2 times.

The mixing section may be provided with screws having decreasing pitch in order to build up pressure-favouring backflow. The backflow results in intensive elongational deformation when polymer is forced to flow between the screws and the barrel wall of the extruder.

According to a further aspect of the invention there is provided a method of homogenizing polymer comprising feeding multimodal polymer powder to the apparatus as previously defined and thereby producing homogenized and formed (e.g pelletised) polymer product. Furthermore, the invention provides a process of manufacturing bimodal polymer wherein bimodal polymer powder is formed and then pelletised as previously described.

Although the method, process and apparatus of the invention are applicable to a range of products, the invention is preferably used in the manufacture of bimodal polymer, such as bimodal polypropylene.

Certain embodiments of the invention will now be described by way of example only and with reference to the accompanying drawings:

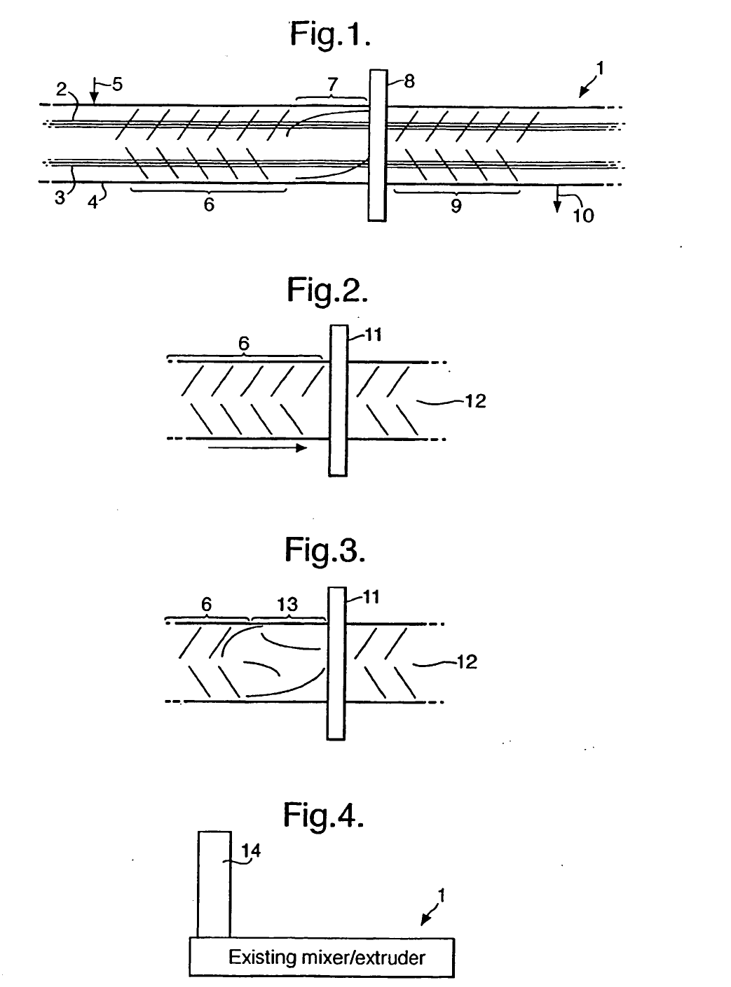

FIG. 1 is a schematic drawing of a typical prior art polyethylene extruder;

FIG. 2 is a schematic drawing of a first modification to the prior art extruder thereby providing an apparatus operating according to a first embodiment of the invention;

FIG. 3 is a schematic drawing of an alternative, modification providing the second embodiment of the invention;

FIG. 4 is a schematic drawing of a still further alternative modification providing the third embodiment of the invention;

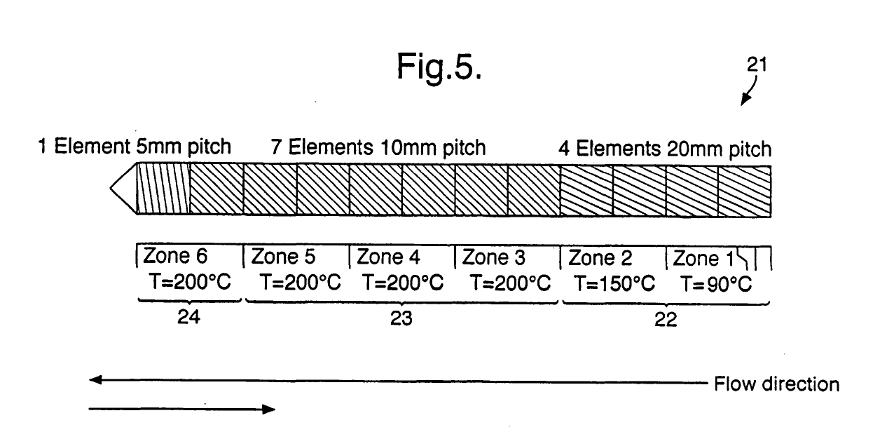

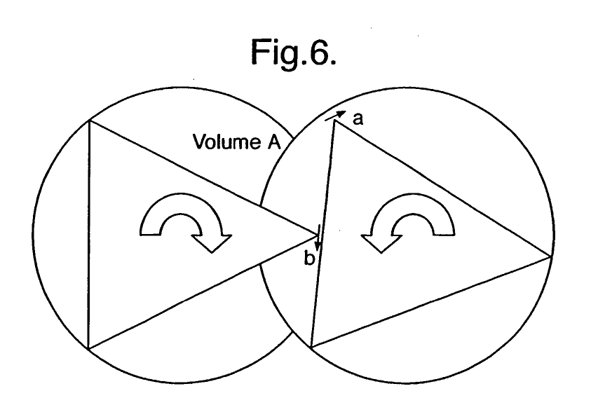

FIG. 5 is a schematic illustration of a fourth embodiment of the invention which is a laboratory scale extruder; and

FIG. 6 is a diagram illustrating schematically the gaps and free volumes within a mixing element.

Turning first to FIG. 1, the illustration corresponds to a typical commercial scale machine. The device 1 has twin counter-rotating screws 2, 3 located within a chamber 4 and is divided into a number of sections along its length.

An inlet conduit 5 is provided into which polymer powder may be fed. The conduit leads to the first section of the extruder which is feeding section 6. This has fine pitched screws and leads in turn to a mixing section 7 having coarsely pitched screws. Here the polymer is melted (due to being worked) and mixed. The screws 2, 3 are arranged within the chamber such that the powder is worked between the screws and against the walls of the chamber. This working results in the frictional heating of the powder that causes it to melt and be thoroughly mixed together. No external heating source is provided.

A gate valve 8 is then provided which controls the flow of polymer from the mixing section 7 and thereby controls the residence time of the polymer within the mixing section. Thus, it creates a controllable degree of backflow within the mixing section 7. Downstream of the gate valve 8 is at transport section 9 leading to conduct 10. This in turn leads to a gear pump (not shown). The gear pump is used to feed the molten polymer to the pelletiser.

In the pelletiser, the molten polymer it is forced through a die containing a large number of small holes. A rotary knife slices through the polymer as it is extruded through these holes to produce small roughly cylindrical pellets.

As may be seen from FIG. 2, according to the first embodiment, additional sections are added to the extruder of FIG. 1. These follow the feeding section of FIG. 1. The first part of the additional section is an extension to the feeding section 6. Downstream of this an additional gate valve 11 is included (at the end of the extended feeding section). Downstream of the gate valve 11 an additional feeding section 12 is provided before the mixer 7.

By means of this arrangement additional heating is provided in the feeding section such that the polypropylene is fully melted in that section before reaching the mixing section 7. Gate valve 11 is used to control the polymer flow to ensure that the polymer is completely molten. In addition, the further feeding section increases to some extent the pressure at which the polymer is fed to other mixer and thereby increases the longitudinal stresses applied to the polymer.

The alternative modification shown in FIG. 3 provides a second embodiment of the invention It is broadly similar to that just described, except that instead of having a simple elongated feeding section, there is also provided a special melting/backflow screw section 13 before the additional gate valve. This section increases the amount of energy applied compared to standard feeding screws, thereby assisting in melting the polymer.

By means of the third modification (forming the third embodiment) illustrated in FIG. 4, a separate single or twin-screw extruder 14 is added before and at right angles to the apparatus of FIG. 1. This is designed to pre-melt the polymer such that melted polymer is fed into the extruder 14. This arrangement has the advantage of not requiring such long screws, which simplifies manufacture.

The above-described features of the embodiments ensure that the polypropylene is thoroughly melted before reaching the mixing section. However, the mixing stage is also modified compared to the standard polyethylene-processing device in order to significantly increase the elongational stress applied to the polymer. Thus, the free volume between the screws and the walls of the device, the gaps between the screws 2 and 3 and the gaps between the screw flights and the walls have been significantly reduced. This results in elongational stresses that create a Hencky strain of approximately 2 within the polymer as it is worked. This in turn creates significant strain hardening within gels of high molecular weight components of the polyethylene. As previously discussed, this means that viscosity is increased creating “brittleness” which allows the gels to be easily broken up.

FIG. 5 illustrates a laboratory scale prototype according to the invention having screws built up from modular “Clextral” components. The extruder 21 comprises twin 25 mm diameter intermeshing counter rotating screws. It has a feeding section 22, a melting section 23 and a mixing section 24. After the polymer powder is introduced into the extruder it is transported from the feeding section through the melting section to the mixing section and then to the extruder itself (not shown).

The feeding section 22 has an l/d value of 6 and comprises four elements on each screw having a 20 mm pitch. These work the polymer such that its temperature reaches 150 C.

The melting section is significantly larger, l/d being 12, and has seven elements arranged at 10 mm pitch. This raises the temperature of the polymer to 200 C, thereby melting it.

Downstream, the mixing section maintains this temperature. It has one element having a 5 mm pitch and l/d is 6.

The overall length of the apparatus, i.e. all twelve elements is 600 mm. The melting section 23 is significantly longer than that normally used and leads to an intensive mixing section where strong backflow is caused by a pressure build up combined with reduced forward feeding capacity due to screw pitch reduction. This provides much greater than normal elongational stress leading to strain hardening as discussed above. The downstream extruding components are conventional.

This apparatus has been used successfully to homogenise bimodal polypropylene in which no significant gels were detectable.

A set of experiments was carried out on this device to compare it to a comparable one in which co-rotating screws were used. This device had 1200 mm screws and three kneading blocks in the mixing section. The experiments used a series of different grades of bimodal polypropylene (materials a, b and c). The results of these experiments are found in the following table:—

| | | | | | | SEI |
|---|---|---|---|---|---|---|
| sample | extruder | rpm | #gels | Kg\t | torque % | (kw\kg) |
| mat a | counter rotating | 100.00 | 29.00 | 1.50 | 68.00 | 194.00 |
| mat a | counter rotating | 100.00 | 0.00 | 2.10 | 89.00 | 206.00 |
| mat a | counter rotating | 100.00 | 31.00 | 0.90 | 49.00 | 181.00 |
| mat b | counter rotating | 100.00 | 44.00 | 1.50 | 68.00 | 194.00 |
| mat d | counter rotating | 100.00 | 10.00 | 1.50 | 75.00 | 226.00 |
| mat e | counter rotating | 100.00 | 19.00 | 1.50 | 81.00 | 263.00 |
| mat c | counter rotating | 100.00 | 4.00 | 1.50 | 75.00 | 226.00 |
| mat a | co- rotating | 150.00 | 0.00 | 1.50 | 93.00 | 461.00 |
| mat c | co- rotating | 150.00 | 0.00 | 1.50 | 91.00 | 447.00 |
| mat d | co- rotating | 150.00 | 5.00 | 1.50 | 90.00 | 440.00 |
| mat e | co- rotating | 150.00 | 11.00 | 2.50 | 90.00 | 264.00 |
| mat b | co- rotating | 150.00 | 23.00 | 2.50 | 93.00 | 276.00 |

Here “mat” is an abbreviation for “material”; the number of gels were counted on a 200×200 mm compression molded plate using a standard image analysis system; the torque quoted is as a percentage of maximum torque; and SEI is the specific energy (strictly power) input, i.e. kilowatts per kilogram of material. It may be seen from this that with suitably selected parameters, bimodal polypropylene having low numbers of gels may be produced. In addition, it may be seen that counter-rotating screws may be used to obtain similar gel levels with a much lower energy input.

1. A method of homogenising polypropylene comprising melting the polypropylene and subjecting it to sufficient elongation stress to cause a significant elongational strain sufficient to break up gels within the polypropylene.

2. A method of homogenizing a polymer comprising the steps of determining the strain-hardening region of the polymer, melting and mixing the polymer, wherein the polymer is subjected to sufficient elongational stress during mixing to cause a significant strain-hardening whereby to break up gels within the polymer.

3. A method as claimed in claim 1, wherein the rate of deformation applied is of at least ten times greater magnitude than that applied in the conventional counter-rotating extruders commonly used for high-density polyethylene.

4. A method as claimed in claim 1, wherein the average effective elongational deformation (Hencky strain) and elongational stress applied to the polymer is increased by at least 20% compared with the conventional counter-rotating extruders commonly used for high density polyethylene.

5. A method as claimed in claim 4, wherein the average effective elongational deformation (Hencky strain) and elongational stress applied to the polymer is increased by at least 50% compared with the conventional counter-rotating extruders commonly used for high density polyethylene.

6. A method as claimed in claim 1, wherein all polymers or modes of polymer forming the material being processed are worked in their strain-hardening region.

7. A method as claimed in claim 1, wherein the elongational stress applied is sufficient to cause a Hencky strain of between 1.5 and 2.5.

8. A method as claimed claim 7, wherein the elongational stress applied is sufficient to cause a Hencky strain of between 1.8 and 2.2.

9. A method as claimed in claim 1, wherein the polymer thereby produced has no visible white spots when tested as described herein.

10. A method as claimed in claim 1, wherein the polymer contains a high molecular weight fraction having a molecular weight greater than 350,000.

11. A method as claimed in claim 1, wherein the method is carried out using a counter-rotating device.

12. A method as claimed in claim 1, wherein the polymer reaches a temperature of at least 5° C. above the melting point of the polymer before reaching the mixing stage.

13. An apparatus for homogenising polypropylene comprising a melting section for melting the polypropylene and a mixing section wherein the polypropylene is subjected to sufficient elongation stress to cause a significant elongational strain sufficient to break up gels within the polypropylene.

14. An apparatus for homogenizing multimodal polypropylene, wherein the apparatus is capable of creating sufficient elongational strain within the polypropylene that polypropylene containing a high molecular weight fraction having a weight average molecular weight of over 500,000 may be homogenized to produce a product with no visible gels.

15. An apparatus for homogenizing multimodal polypropylene comprising twin counter-rotating screws located within a housing which serve to melt and mix polymer and feed it to a downstream forming device, the apparatus comprising a melting stage and a separate downstream mixing stage, wherein the melting stages raises the temperature of the polypropylene to a temperature above its melting point before it reaches the mixing stage.

16. An apparatus for homogenizing multimodal polypropylene comprising twin counter-rotating screws located within a housing which serve to melt and mix polymer and feed it to a downstream forming device, wherein the apparatus comprises a melting stage which raises the temperature of the polypropylene to a temperature above its melting point, a mixing stage in which sufficient elongational stress is applied to cause significant strain hardening in the polypropylene and a forming stage, the stages being separated from each other along the length of the screws.

17. An apparatus as claimed in claim 16, further comprising a gate valve between the melting section and the mixing section.

18. An apparatus as claimed in claim 16, wherein a distinct feeding section is provided upstream of the melting section.

19. An apparatus as claimed in claim 16, further comprising a pre-melting stage upstream of the apparatus defined in that claim.

20. (canceled)

21. A method of producing homogenised multimodal polymer comprising the use of the method or apparatus of claim 1.
